(19) United States
(12) Patent Application Publication
(10) Pub. No.: US 2015/0116196 A1
(43) Pub. Date: Apr. 30, 2015

(54) LED DISPLAY MODULE, AN LED TV AND AN LED TV SYSTEM

(71) Applicant: Shenzhen Liantronics Co., Ltd., Shenzhen, Guangdong (CN)

(72) Inventors: Yifeng Liu, Shenzhen (CN); Hujun Liu, Shenzhen (CN); Hanping Liu, Shenzhen (CN)

(73) Assignee: Shenzhen Liantronics Co., Ltd., Shenzhen, Guangdong (CN)

(21) Appl. No.: 13/989,655

(22) PCT Filed: Nov. 12, 2012
(86) PCT No.: PCT/CN2012/084436

§ 371 Date: May 24, 2013

(30) Foreign Application Priority Data
Jun. 20, 2012 (CN) 201210205476.X

(51) Int. Cl. G06F 3/00

(52) U.S. Cl. CPC G06F 3/005
USPC 345/156

(57) ABSTRACT

The present invention discloses an LED display module, an LED TV and an LED TV system, wherein a camera component is embedded on the LED display module; in this way, the LED TV is capable of taking pictures from middle of the display screen; because the participants are looking at the display screen, as a result, the local participants at local and the other end can look in the eyes, which improves sensory feeling of video interaction and realizes getting more information from the eye expression; because the camera component can take pictures from the front side, accuracy of taken feature information is improved; and the accurate feature information can facilitate accurate subsequent action analysis; as a result, the present invention realizes wider application of LED TV.

### TECHNICAL FIELD

The present invention relates to LED field, specifically to an LED display module, an LED TV and an LED TV system.

### BACKGROUND ART

Lighting Emitting Diode (hereinafter refer as LED) is a solid semiconductor device that is capable of converting electric energy into visible light. LED is widely used for display, illumination and so on. Traditional Cathode Ray Tube TV is also replaced by the TV with LED application, that is, LED TV. At present, when the LED TV is used for interaction like video conference, a camera component is arranged at four sides of the LED TV in order to finish video recording at local and video display at the other end without influencing normal video display function of the LED TV. However, because the participants usually sit right ahead of the LED TV and look at the LED TV screen, the camera component cannot take the front faces of the participants due to the angle problem, and the participant at the other end cannot see the front face of the local participants, which causes incongruous sensory feeling to the participants and the participants cannot get more information from the eye expression. In addition, because the camera component cannot take front picture of the other party, the feature information such as body action cannot be got exactly for the subsequent analysis and judgment. These disadvantages impose restrictions on application of LED TV.

### SUMMARY OF THE INVENTION

The technical problem to be solved by embodiment of the present invention is to provide an LED display module, an LED TV and an LED TV system, so as to improve sensory feeling of video interaction, realize sufficient amount of interaction information and improve accuracy of taken feature information, thus to realize wider application of LED TV.

The further technical problem to be solved by embodiment of the present invention is to provide an LED display module that comprises LED display units, wherein camera component is embedded on the LED display module.

Further, the LED display units form the LED display module according to pixel matrix and the camera component occupies one pixel of the matrix.

Further, the LED display units form the LED display module according to pixel matrix and the camera component locates at the area among the pixels of the matrix.

Accordingly, the present invention further provides an LED TV comprising an LED display module that is comprised of a plurality of the LED display units.

Further, the camera component locates at middle part of the display screen of the LED TV.

Accordingly, the present invention further provides an LED TV system comprising the LED TV, an image processing unit that is connected with the camera component to carry out image processing to the input data of the camera component, and an embedded computer system that is connected with the image processing unit to interact the data from image processing with external system.

Accordingly, the present invention further provides an LED TV system, comprising the LED TV, an image processing unit that is connected with the camera component to form initial image with the input data of the camera component and extract feature information of the initial image, and an embedded computer system that is connected with the image processing unit to analyze the feature information.

Further, the external system is an electronic interaction game system, a video interaction advertisement system, a video interaction market investigation system, an experiential audio-visual system, a mouse keyboard system, a virtual reality system, a virtual sand table module or a virtual driving system.

Further, the feature information is eye expression feature information or body action feature information having time difference.

The beneficial effects of embodiment of the present invention are as follows:

By providing an LED display module, an LED TV and an LED TV system, and embedding camera component on the LED display module, the LED TV is capable of taking pictures from middle of the display screen. Because the participants are looking at the display screen, as a result, the local participants at local and the other end can look in the eyes, which improves sensory feeling of video interaction and realizes getting more information from the eye expression; because the camera component can take pictures from the front side, accuracy of taken feature information is improved. The accurate feature information can facilitate accurate subsequent action analysis. As a result, the present invention realizes wider application of LED TV.

### BRIEF DESCRIPTION OF THE DRAWINGS

FIG. 1 is front view of the LED TV of the embodiment of the present invention.

FIG. 2 is space diagram of the LED display module 1 of the embodiment of the present invention.

FIG. 3 is detailed drawing of the LED display module 1 of the embodiment of the present invention.

FIG. 4 is the structural drawing of the camera component 2 of the embodiment of the present invention.

FIG. 5 is the structural schematic drawing of the LED TV system of the embodiment of the present invention.

### DETAILED DESCRIPTION OF THE PREFERRED EMBODIMENTS

It's important to note that the embodiments and features in the embodiments of the application can be combined with each other in the case having no conflict. The detailed explanation in combination with drawings and embodiments is as follows:

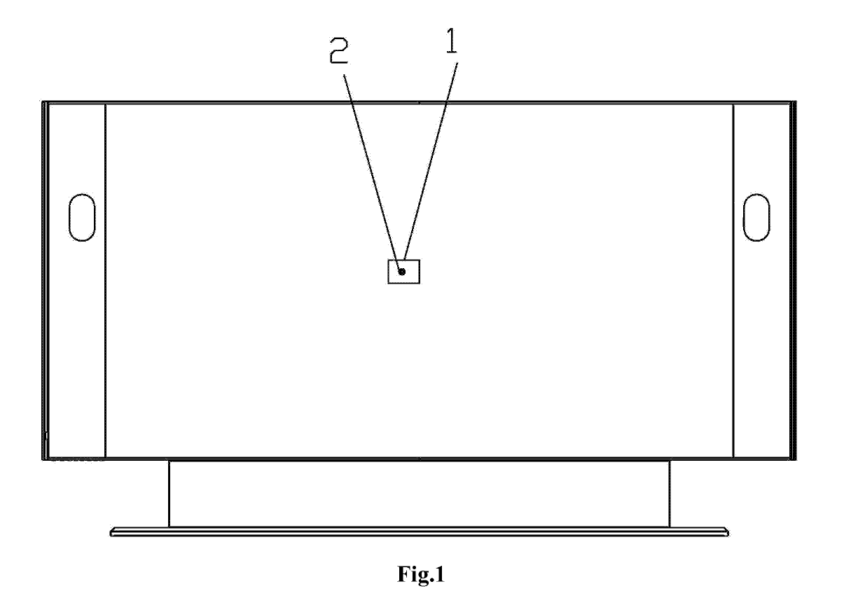

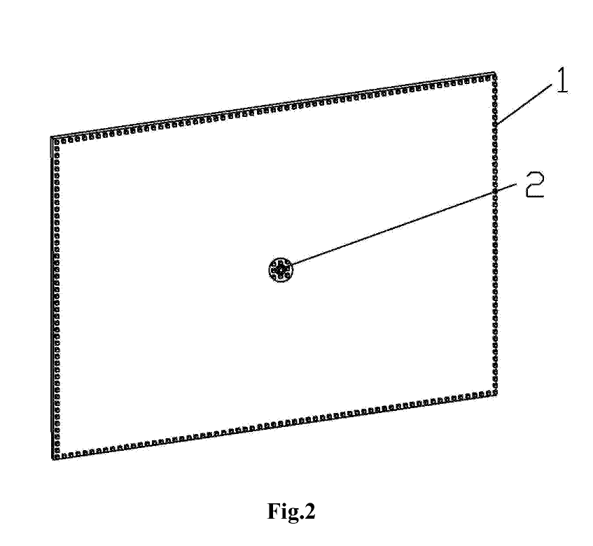

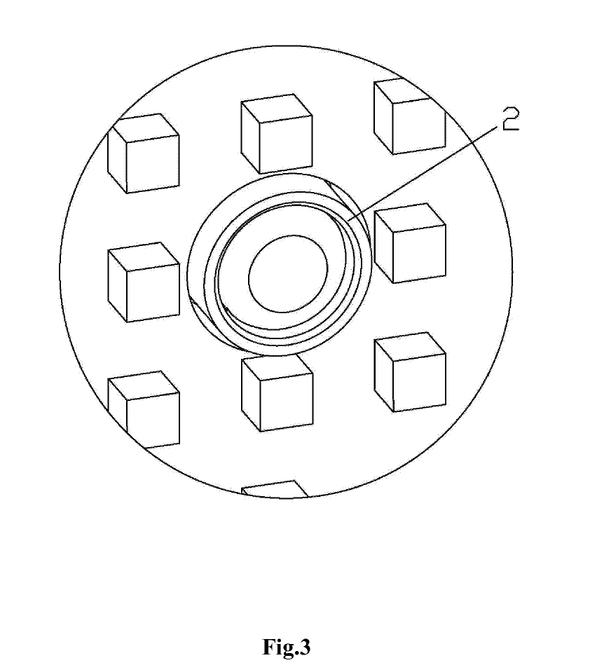

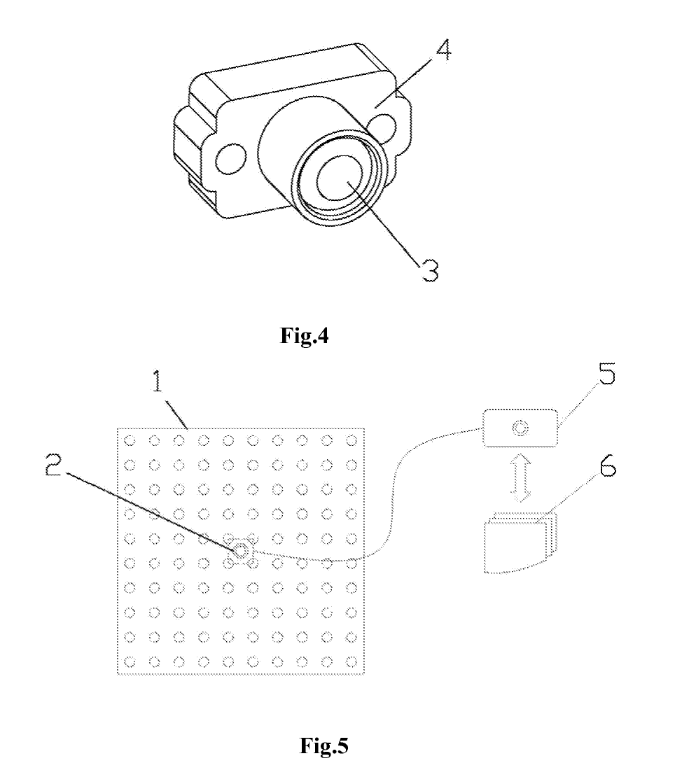

As shown in FIG. 1, the embodiment provides an LED TV comprising an LED display module which is comprised of a plurality of LED display units. The display screen of the LED TV is made by assembling a plurality of LED display modules. Each LED display unit can be made by encapsulating one LED chip. One of the LED display modules 1 can be as shown in FIG. 2 and FIG. 3, and a camera component 2 is arranged on the LED display module 1. The camera component 2 can include the structure as shown in FIG. 4, namely a camera 3, peripheral wire and an assembly fixing structure 4. The camera component locates in the middle of the display screen of the LED TV, which can be realized by setting position of LED display module 1.

As shown in FIG. 2 and FIG. 3, the LED display units form the LED display module 1 according to pixel matrix, and the camera component 2 occupies one pixel point in the matrix. As one implementation way, the camera component 2 can also locate at the area among the pixels in the matrix without occupying one pixel point in the matrix.

In assembling, the camera component 2 can be assembled at the middle part of the LED display module, or at the edge of the LED display module.

As one implementation way, the LED display module can be provided with a plurality of camera components 2, so as to obtain images from multiple angles for subsequent interaction or analysis.

Accordingly, the embodiment also provides an LED TV system, as shown in FIG. 6, comprising the LED TV, an image processing unit 5 that is connected with the camera component 2 to carry out image processing to the input data of the camera component 2, and an embedded computer system 6 that is connected with the image processing unit 5 to interact the data from image processing with external system. In this way, static image or active video taken by the camera component 2 is used as input data, after image processing, the data is sent to external system by the embedded computer system 6 for interaction. Therefore, it can be used for video conference and so on.

Accordingly, the embodiment also provides another LED TV system, as shown in FIG. 5, comprising the LED TV, an image processing unit 5 that is connected with the camera component 2 to form initial image with the input data of the camera component 2 and extract feature information of the initial image, and an embedded computer system 6 that is connected with the image processing unit 5 to analyze the feature information. In this way, static image or active video taken by the camera component 2 is used as input data, after feature information extraction, the data is analyzed by the embedded computer system 6, so the information like eye expression feature information or body action feature information can be used for action analysis due to the time difference, and the “action” from the analysis can be used for the electronic interactive game system, the video interactive advertisement system, the video interactive market investigation system, the experiential audio-visual system, the mouse keyboard system, the virtual reality system, the virtual sand table module or the virtual driving system that carries out relative data processing according to the analysis result. For example, when the eye expression feature information indicates that the eye ball slides from left to right, this “action” can be figured out by analysis from the eye expression feature information in the image frames having time difference; when this “action” is defined as left-click of the mouse, it will trigger the left-click function of mouse. In the same way, this implementation way can also be used for application based on body action feature information or other feature information.

It is important to note that the above two LED TV systems can be combined to make another LED TV system with video interaction and “action” analysis processing functions.

Despite of the description of the embodiments of the present invention, it is possible for the common technical personnel of the field to make multiple changes, modifications, replacements and reshaping based on the principle and spirit of the present invention, which should also belong to the protection scope of the present invention. The scope of the present invention is defined by the claims and the identical scope.

1. An LED display module, comprising LED display units, wherein camera component is embedded on the LED display module.

2. The LED display module according to claim 1, wherein the LED display units form the LED display module according to pixel matrix and the camera component occupies one pixel of the matrix.

3. The LED display module according to claim 1, wherein the LED display units form the LED display module according to pixel matrix and the camera component locates at the area among the pixels of the matrix.

4. An LED TV, comprising an LED display module that is comprised of the LED display units according to claim 1.

5. The LED TV according to claim 4, wherein the camera component locates at middle part of the display screen of the LED TV.

6. An LED TV system, comprising the LED TV according to claim 4, an image processing unit that is connected with the camera component to carry out image processing to the input data of the camera component, and an embedded computer system that is connected with the image processing unit to interact the data from image processing with external system.

7. An LED TV system, comprising the LED TV according to claim 4, an image processing unit that is connected with the camera component to form initial image with the input data of the camera component and extract feature information of the initial image, and an embedded computer system that is connected with the image processing unit to analyze the feature information.

8. The LED TV system according to claim 7, wherein the external system is an electronic interaction game system, a video interaction advertisement system, a video interaction market investigation system, an experiential audio-visual system, a mouse keyboard system, a virtual reality system, a virtual sand table module or a virtual driving system.

9. The LED TV system according to claim 7, wherein the feature information is eye expression feature information or body action feature information having time difference.

10. An LED TV, comprising an LED display module that is comprised of the LED display units according to claim 2.

11. An LED TV, comprising an LED display module that is comprised of the LED display units according to claim 3.

12. The LED TV according to claim 10, wherein the camera component locates at middle part of the display screen of the LED TV.

13. The LED TV according to claim 11, wherein the camera component locates at middle part of the display screen of the LED TV.

14. An LED TV system, comprising the LED TV according to claim 10, an image processing unit that is connected with the camera component to carry out image processing to the input data of the camera component, and an embedded computer system that is connected with the image processing unit to interact the data from image processing with external system.

15. An LED TV system, comprising the LED TV according to claim 11, an image processing unit that is connected with the camera component to carry out image processing to the input data of the camera component, and an embedded computer system that is connected with the image processing unit to interact the data from image processing with external system.

16. An LED TV system, comprising the LED TV according to claim 10, an image processing unit that is connected with the camera component to form initial image with the input data of the camera component and extract feature information of the initial image, and an embedded computer system that is connected with the image processing unit to analyze the feature information.

17. An LED TV system, comprising the LED TV according to claim 11, an image processing unit that is connected with the camera component to form initial image with the input data of the camera component and extract feature information of the initial image, and an embedded computer system that is connected with the image processing unit to analyze the feature information.

18. The LED TV system according to claim 16, wherein the external system is an electronic interaction game system, a video interaction advertisement system, a video interaction market investigation system, an experiential audio-visual system, a mouse keyboard system, a virtual reality system, a virtual sand table module or a virtual driving system.

19. The LED TV system according to claim 17, wherein the external system is an electronic interaction game system, a video interaction advertisement system, a video interaction market investigation system, an experiential audio-visual system, a mouse keyboard system, a virtual reality system, a virtual sand table module or a virtual driving system.

20. The LED TV system according to claim 16, wherein the external system is an electronic interaction game system, a video interaction advertisement system, a video interaction market investigation system, an experiential audio-visual system, a mouse keyboard system, a virtual reality system, a virtual sand table module or a virtual driving system.

21. The LED TV system according to claim 17, wherein the external system is an electronic interaction game system, a video interaction advertisement system, a video interaction market investigation system, an experiential audio-visual system, a mouse keyboard system, a virtual reality system, a virtual sand table module or a virtual driving system.
